(19) United States
(12) Patent Application Publication
(10) Pub. No.: US 2011/0088076 A1
(43) Pub. Date: Apr. 14, 2011

(54) System and Method for Media Adaptation

(75) Inventors: Hongbing Li, Belle Mead, NJ (US); Peng Zhang, Beijing (CN); Yunchao Gao, Beijing (CN); Ye-Kui Wang, Bridgewater, NJ (US); Yue Chen, San Jose, CA (US); Hong Heather Yu, West Windsor, NJ (US)

(73) Assignee: FutureWei Technologies, Inc., Plano, TX (US)

(21) Appl. No.: 12/837,934

(22) Filed: Jul. 16, 2010

Related U.S. Application Data
(60) Provisional application No. 61/249,827, filed on Oct. 8, 2009.

(51) Int. Cl. H04N 7/173

(52) U.S. Cl. 725/114

(57) ABSTRACT

A system and method for media adaptation are provided. A method for providing media to an electronic device includes receiving a request for a media with a set of characteristics, and determining if the media with the set of characteristics resides in a media storage. The method also includes if the media with the set of characteristics resides in the media storage, retrieving the media with the set of characteristics from the media storage. The method further includes if the media with the set of characteristics does not reside in the media storage, transcoding an alternate media with an alternate set of characteristics to produce a transcoded media with the set of characteristics. The method additionally includes providing the media with the set of characteristics from the media storage or the transcoded media with the set of characteristics to the electronic device.

This application claims the benefit of U.S. Provisional Application No. 61/249,827, filed on Oct. 8, 2009, entitled “Combination of Multiple Bit rate Switching and On Demand Transcoding for Fine Grained Media Adapatation,” which application is hereby incorporated herein by reference.

### TECHNICAL FIELD

The present invention relates generally to a system and method for digital communications, and more particularly to a system and method for media adaptation.

### BACKGROUND

Delivering media (also commonly referred to as content), such as movies, music, multimedia, and so forth, over communications systems has become a viable method for providing information and entertainment to users. However, the users may utilize different devices with different capabilities or requirements to view the content. As an example, some users may view media on their high-definition televisions at extremely high resolution (high resolution may be analogous to high bit-rate), while other users may view media on their computer screen at a medium resolution (or medium bit-rate), and there may be a significant number of users that view media on a handheld communications device, such as a third generation or fourth generation smart telephone, at a relatively low resolution (or low bit-rate). Clearly, delivering a high definition video to a handheld communications device is a waste of communications system bandwidth, while a low definition video being viewed on a high-definition television will result in poor customer satisfaction.

Therefore, there is a need to deliver media at an appropriate resolution (bit-rate) depending on a user's requirements. The ability to deliver media at different bit-rates, where the bit-rate is dependent on a user's requirements is commonly referred to as media adaptation. However, currently used media adaptation technologies may incur high storage requirements and/or high computational load requirements.

Multiple bit-rate (MBR) switching and transcoding are two commonly adopted media adaptation technologies. In MBR, media may be prepared (encoded) and stored at a variety of bit-rates. Then, the media may be delivered to the user at a bit-rate consistent with the user's requirements. Preparing multiple bit-rate media in advance may have an advantage of media delivery with low computation cost and high performance since the media is already encoded and no additional encoding is required.

With transcoding, media may be prepared (encoded) and stored at a single bit-rate and then dynamically transcoded (re-encoded) at a bit-rate consistent with the user's requirements. Transcoding may allow for the support of a large number of bit-rates since media only needs to be stored at a single bit-rate and then transcoded to any desired bit-rate.

### SUMMARY OF THE INVENTION

These and other problems are generally solved or circumvented, and technical advantages are generally achieved, by preferred embodiments of the present invention which provide a system and method for media adaptation.

In accordance with a preferred embodiment of the present invention, a method for providing media to an electronic device is provided. The method includes receiving a request for a media with a set of characteristics, and determining if the media with the set of characteristics resides in a media storage. The method also includes if the media with the set of characteristics resides in the media storage, retrieving the media with the set of characteristics from the media storage. The method further includes if the media with the set of characteristics does not reside in the media storage, transcoding an alternate media with an alternate set of characteristics to produce a transcoded media with the set of characteristics. The method additionally includes providing the media with the set of characteristics from the media storage or the transcoded media with the set of characteristics to the electronic device.

In accordance with another preferred embodiment of the present invention, a method for providing media to an electronic device is provided. The method includes receiving a request for a media with a set of characteristics, and determining if the media with the set of characteristics resides in a media storage. The method also includes if the media with the set of characteristics resides in the media storage, retrieving the media with the set of characteristics from the media storage. The method further includes if the media with the set of characteristics does not reside in the media storage, transcoding an alternate media with an alternate set of characteristics to produce a transcoded media with the set of characteristics, or retrieving the media with the set of characteristics from a media server. The method additionally includes providing the media with the set of characteristics from the media storage, the media with the set of characteristics from the media server, or the transcoded media with the set of characteristics to the electronic device.

In accordance with another preferred embodiment of the present invention, an electronic device is provided. The electronic device includes a receiver, a transmitter, a controller coupled to the transmitter and to the receiver, and a memory coupled to the controller, to the receiver, and to the transmitter. The receiver receives incoming information from a data input port, the transmitter transmits outgoing information to a data output port, and the controller combines fixed bit-rate media with on demand transcoding of media fragments to produce a media stream with support for a wide range of properties. The memory stores media fragments.

An advantage of an embodiment is that the capabilities of MBR and transcoding may be exploited to provide support for a large number of bit-rates without requiring a large amount of media storage and/or a large amount of computational capability.

A further advantage of an embodiment is that the computational requirements are not significantly increased as a communications system scales and supports larger numbers of users.

The foregoing has outlined rather broadly the features and technical advantages of the present invention in order that the detailed description of the embodiments that follow may be better understood. Additional features and advantages of the embodiments will be described hereinafter which form the subject of the claims of the invention. It should be appreciated by those skilled in the art that the conception and specific embodiments disclosed may be readily utilized as a basis for modifying or designing other structures or processes for carrying out the same purposes of the present invention. It should also be realized by those skilled in the art that such equivalent constructions do not depart from the spirit and scope of the invention as set forth in the appended claims.

### BRIEF DESCRIPTION OF THE DRAWINGS

For a more complete understanding of the present invention, and the advantages thereof, reference is now made to the following descriptions taken in conjunction with the accompanying drawing, in which:

FIG. 1 is a diagram of a delivery of media in a communications system;

FIG. 2a is a diagram of a server;

FIG. 2b is a diagram of a detailed view of a control unit shown in FIG. 2a;

FIG. 3a is a diagram of a video fragment;

FIG. 3b is a diagram of an audio fragment;

FIG. 4 is a diagram of a first storage structure of media fragments;

FIG. 5 is a diagram of a storage structure of media fragments with additional prepared metadata;

FIG. 6a is a diagram of a metadata format for a video track;

FIG. 6b is a diagram of a metadata format for an audio track;

FIG. 6c is a diagram of a media description of alternative tracks;

FIG. 7 is a diagram of a data flow for a combination of MBR with on demand transcoding;

FIG. 8 is a diagram of a storage structure of media fragments with additional prepared metadata and media fragments transcoded using on demand transcoding;

FIG. 9 is a flow diagram of operations in combining MBR with on demand transcoding;

FIG. 10 is a flow diagram of operations in combining MBR with on demand transcoding in a media delivery communications system;

FIG. 11a is a flow diagram of first server operations in a delivery of media to a UE, wherein media adaptation using a combination of MBR and on demand transcoding is utilized; and

FIG. 11b illustrates a flow diagram of second server operations in a delivery of media to a UE, wherein media adaptation using a combination of MBR and on demand transcoding is utilized.

### DETAILED DESCRIPTION OF ILLUSTRATIVE EMBODIMENTS

The making and using of the presently preferred embodiments are discussed in detail below. It should be appreciated, however, that the present invention provides many applicable inventive concepts that can be embodied in a wide variety of specific contexts. The specific embodiments discussed are merely illustrative of specific ways to make and use the invention, and do not limit the scope of the invention.

The present invention will be described with respect to preferred embodiments in a specific context, namely a communications system that provides media to users at a number of bit-rates depending on the capabilities of the users' equipment.

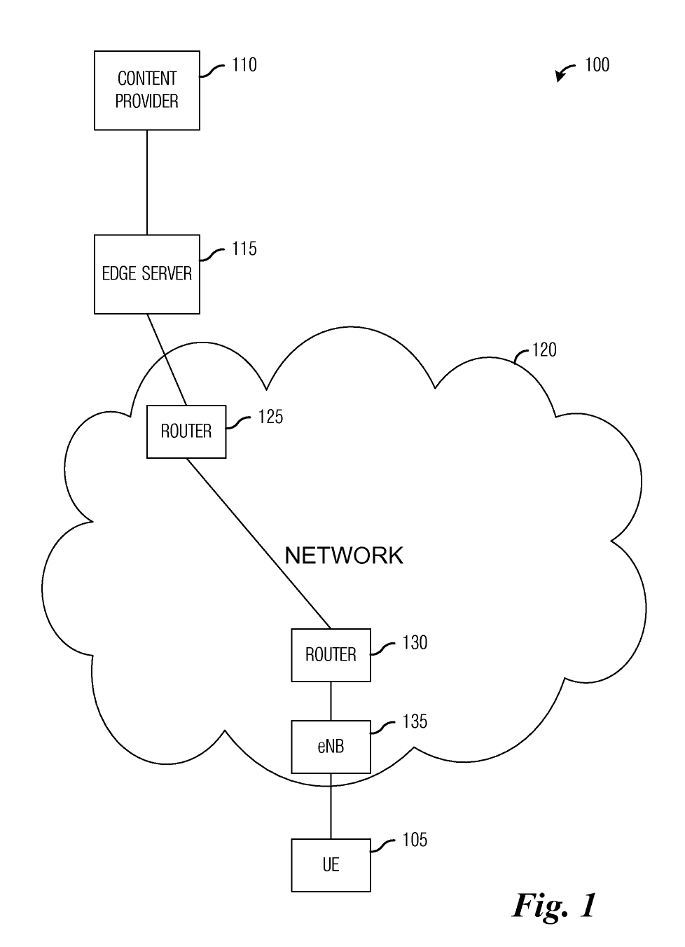

FIG. 1 illustrates a delivery of media in a communications system 100. As shown in FIG. 1, media is delivered to a user equipment (UE) 105, also commonly referred to as a subscriber, user, terminal, mobile station, and so forth, from a content provider 110. The media delivered to UE 105 from content provider 110 may be a result of a media request from UE 105. Depending on capabilities of UE 105, available bandwidth, user preferences, and so on, the media may be provided at one of several bit-rates (resolutions). As an example, if UE 105 is a high-definition display, the media may be provided at a high-definition resolution, such as 1080p, 1080i, 720p, 720i, or so forth, while if UE 105 is a computer then the media may be provided at standard computer display resolutions, such as 1024×768, 640×480, or so on. Furthermore, if UE 105 is a smart telephone, the media may be provided at a relatively low resolution that matches the capabilities of the smart telephone, such as 320×240, 352×288, or so forth. Generally, the media's resolution may be analogous to the bit-rate of the media, with higher resolutions typically corresponding to higher bit-rates. Collectively, the bit-rate, resolution, frame rate, sample size, codec, and so forth, may be referred to as a set of characteristics of the media.

The media provided by content provider 110 may be sent to an edge server 115, which may be a server positioned on an edge between two networks, such as a private network (e.g., a network provided by a service provider to its subscribers) and a public network (e.g., the Internet). Edge server 115 may provide operations, such as security (firewall, router, etc.), application (load balancing, etc.), and delivery (forward information, such as media, mail, and so on, to internal servers in the private network).

Edge server 115 may deliver the media from content provider 110 to UE 105. As shown in FIG. 1, the media may be delivered to UE 105 over network 120 through routers, such as router 125 and router 130, to an enhanced NodeB (eNB) 135, also commonly referred to as a base station, base terminal station, communications controller, and so forth. eNB 135 may control transmissions to and from UE 105 by allocating network resources to UE 105.

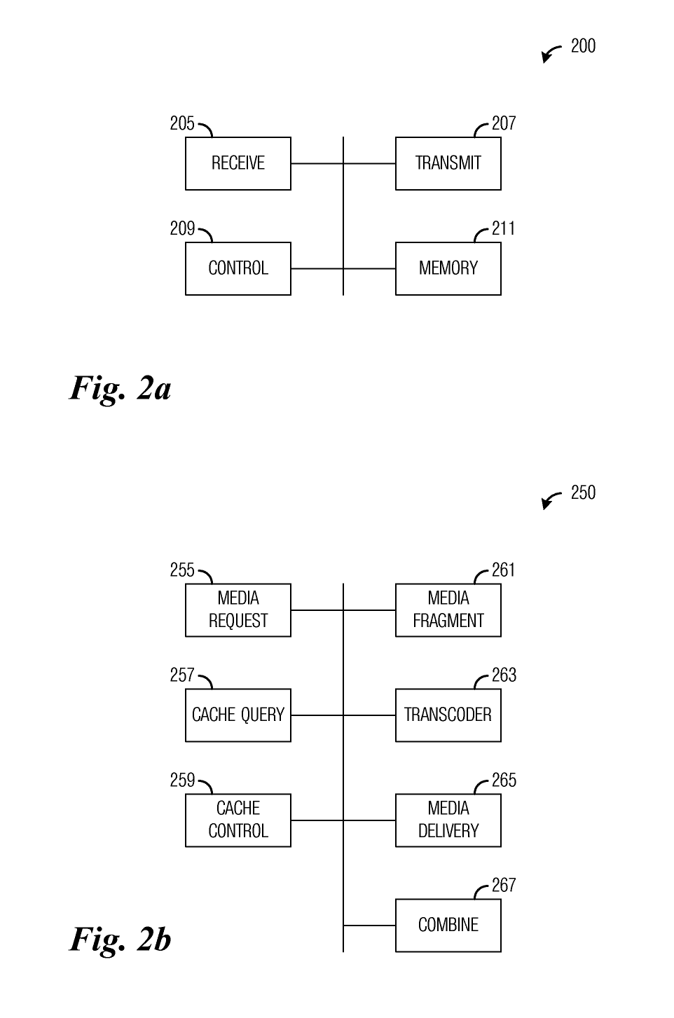

FIG. 2a illustrates a server 200. Server 200 may be an edge server, operating between a private network and a public network, controlling a delivery of information, such as media, to users in the private network. Server 200 may include a receive unit 205 that may be used to receive incoming information. Server 200 may also include a transmit unit 207 that may be used to transmit outgoing information. In general, information may arrive at server 200 through receive unit 205 and may leave server 200 through transmit unit 207.

Since server 200 may be a wireless device, a wireline device, or a combination wireless and wireline device, receive unit 205 and transmit unit 207 may be wireless receive/transmit units, wireline receive/transmit units, or a combination wireless/wireline receive/transmit units. The subsequent discussion does not differentiate between wireless and wireline operation since logically they may be identical.

Server 200 may also include a control unit 209. Control unit 209 may be implemented using a general purpose or special purpose processor or controller, combinatorial logic, state machines, or a combination thereof. Control unit 209 may be used to control the operation of server 200. Server 200 also includes a memory 211 that may be used to store information, buffer media fragments are they are received or as they are being transmitted, provide long term storage for media fragments, scratch memory, and so forth. Memory 211 may be a combination of read-only memory, random access memory, programmable read-only memory, hard disk, and so on.

Control unit 209 may also be used to control the delivery of media to UEs. Control unit 209 may make use of a combination of MBR and on demand transcoding to help provide support for a large number of different bit-rates/resolutions/etc. without having to store a lot of different versions of media. Furthermore, the use of the combination of MBR and on demand transcoding may help to provide scalability for server 200 as a communications system served by server 200 increases in size and supported UEs.

FIG. 2b illustrates a detailed view of a control unit 250. Control unit 250 may be an implementation of control unit 209 of FIG. 2a. Control unit 250 may include a media request unit 255, a cache query unit 257, a cache control unit 259, a media fragment unit 261, a transcoder unit 263, a media delivery unit 265, and a combine unit 267.

Media request unit 255 may be used to process incoming media requests from UEs served by a server containing control unit 250. As an example, media request unit 255 may receive an incoming media request from a UE and based on the incoming media request control a delivery of media requested in the incoming media request to the UE. Media request unit 255 may control the use of both MBR and on demand transcoding to deliver the media to the UE. Media request unit 255 may be implemented from combinatorial logic, boolean functions, programmable gate arrays, or so on.

Cache query unit 257 may be used to determine if a media fragment at a bit-rate/resolution/etc. as specified in the incoming media request is present in a media fragment cache. Examples of bit-rate/resolution/etc. includes a media bit-rate, a video resolution, a video frame rate, an audio bit-rate, an audio sample size, and so forth. According to an embodiment, cache query unit 257 may simply search in the media fragment cache for the media fragment at the specified bit-rate/resolution/etc. According to an alternative embodiment, cache query unit 257 may utilize a hashing function to speed up the search for the media fragment. Cache query unit 257 may be implemented from combinatorial logic, boolean functions, programmable gate arrays, or so on.

Cache control unit 259 may be used to implement cache control functions such as cache clean up to ensure that there is adequate cache storage to store the media fragments. Cache control unit 259 may make use of protocols such as first in first out, least recently used, least frequently used, or a combination thereof to maintain the media fragment cache. Cache control unit 259 may also be used to control a storing and a retrieving of media fragments from the media fragment cache. Cache control unit 259 may be implemented from combinatorial logic, boolean functions, programmable gate arrays, or so on.

Media fragment unit 261 may be used to generate media fragments from media. According to an embodiment, the media fragments may be generated so that the media fragments are of a consistent size and information between the various media fragments remain synchronized. Media fragment unit 261 may be implemented from combinatorial logic, boolean functions, programmable gate arrays, or so on.

Transcoder unit 263 may be used to transcode a media fragment from a first bit-rate/resolution/etc. to a second bit-rate/resolution/etc. In general, the first bit-rate/resolution/etc. will be higher than the second bit-rate/resolution/etc. However, techniques may be used to allow for transcoding from a lower bit-rate/resolution/etc. to a higher bit-rate/resolution/etc. Transcoder unit 263 may be implemented as an algorithm executing on a processor, controller, application specific unit, gate arrays, or so forth.

Media delivery unit 265 may be used to control a delivery of media fragments to the UE. Media delivery unit 265 may be used to ensure that a proper sequencing of the media fragments, e.g., based on a numbering of the media fragments, is ensured so that the UE may receive the media fragments in the proper sequence. Media delivery unit 265 may be implemented from combinatorial logic, boolean functions, programmable gate arrays, or so on.

Combine unit 267 may be used to combine media fragments from the media fragment store, media fragments from the origin server, and transcoded media fragments into a media stream that may be provided to the UE. Combine unit 267 may determine the presence of media fragments in the media fragment store and in the origin server and elect to transcode a media fragment if neither the media fragment store nor the origin server has the media fragment. Combine unit 267 may be implemented from combinatorial logic, boolean functions, programmable gate arrays, or so on.

In order to cope with variations in available network bandwidth, UE capabilities, user preferences, and so forth, media may be provided at a variety of alternatives, e.g., media at a number of different bit-rates, resolutions, frame rates, and so on, for media adaptation in a media preprocessing stage.

To combine on demand transcoding and offer efficient caching with MBR, the media may be fragmented, i.e., the media may be stored as fragments as specified in an ISO based media file format rather than in its entirety, in a synchronized manner. A media fragmentation technique may be as follows:
Preferably, each media fragment has a fixed time duration, for example, 2000 milliseconds, with an exception of a last media fragment which contains a remainder of a media clip and may have a different duration and/or number of frames;
Preferably, each video fragment contains an integer number of groups of pictures (GOPs), for example, exactly one GOP;
Preferably, a first video frame of each GOP is a random access point, and GOPs are of a fixed length, in time duration and/or number of video frames;
Audio fragmentation may be aligned in time with video fragmentation as closely as possible;
Preferably, each audio fragment contains an integer number of encoded audio samples;
Depending on audio sampling rate and audio encoding sample size, an audio fragment may not have exactly a same time duration as a corresponding video fragment, but a closest one may be chosen. For example, a process to align an audio fragment to a corresponding video fragment is as follows: assume that Dv, represents a duration of a video fragment i, Daᵢ₍ₙ₎ represents a duration of an audio fragment i containing n samples, Daᵢ₍ₙ₋₁₎ represents a duration of an audio fragment i containing n−1 samples, Daᵢ₍ₙ₊₁₎ represents a duration of an audio fragment i containing n+1 samples. Preferably, both conditions |Dvᵢ-Daᵢ₍ₙ₎|<|Dvᵢ-Daᵢ₍ₙ₋1)| and |Dvᵢ-Daᵢ₍ₙ₎|<|Dvᵢ-Daᵢ₍ₙ₊₁₎| are met to determine the value n, a number of audio samples contained in an audio fragment.

Although the discussion of the embodiments focuses on media adaptation with media fragments, the embodiments may be operable with media in its entirety. Therefore, the discussion of media fragments and fragmenting media should not be construed as being limiting to either the scope or the spirit of the embodiments.

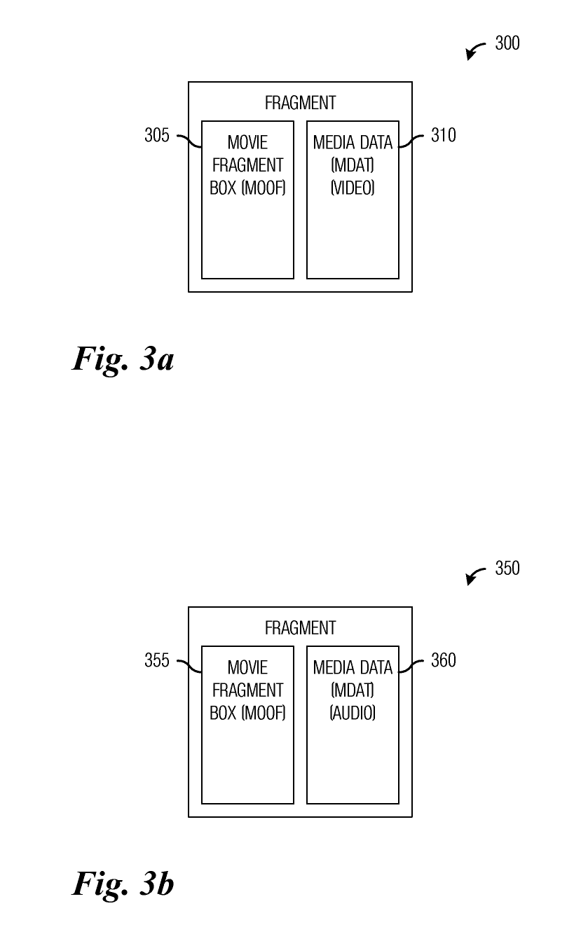

FIG. 3a illustrates a video fragment 300. Video fragment 300 comprises a movie fragment box 305 (a moof box) that follows an ISO based Media File Format specification, and contains information regarding a type, size, and location of each sample in media data 310 (mdat box).

There may be multiple alternative video tracks with different quality levels, and each track may have multiple movie fragments. Each video fragment may be referred to as “v_xx_yyyyy.frv,” where xx represents a multi-digit (such as two digits) video track identifier, yyyyy represents a multi-digit (such as five digits) fragment sequence number. As an example, “v_{—}01_{—}00001.frv” may be a first video fragment of a first video track.

FIG. 3b illustrates an audio fragment 350. Audio fragment 300 comprises a movie fragment box 355 (a moof box) that follows an ISO based Media File Format specification, and contains information regarding a type, size, and location of each sample in media data 360 (mdat box).

There may be multiple alternative audio tracks with different quality levels, and each track may have multiple audio fragments. Each audio fragment may be referred to as “a_xx_yyyyy.frv,” where xx represents a multi-digit (such as two digits) audio track identifier, yyyyy represents a multi-digit (such as five digits) fragment sequence number. As an example, “a_{—}01_{—}00001.frv” may be a first audio fragment of a first audio track.

After fragmentation, multiple media alternatives may be stored as many small files corresponding to multiple tracks with multiple fragments.

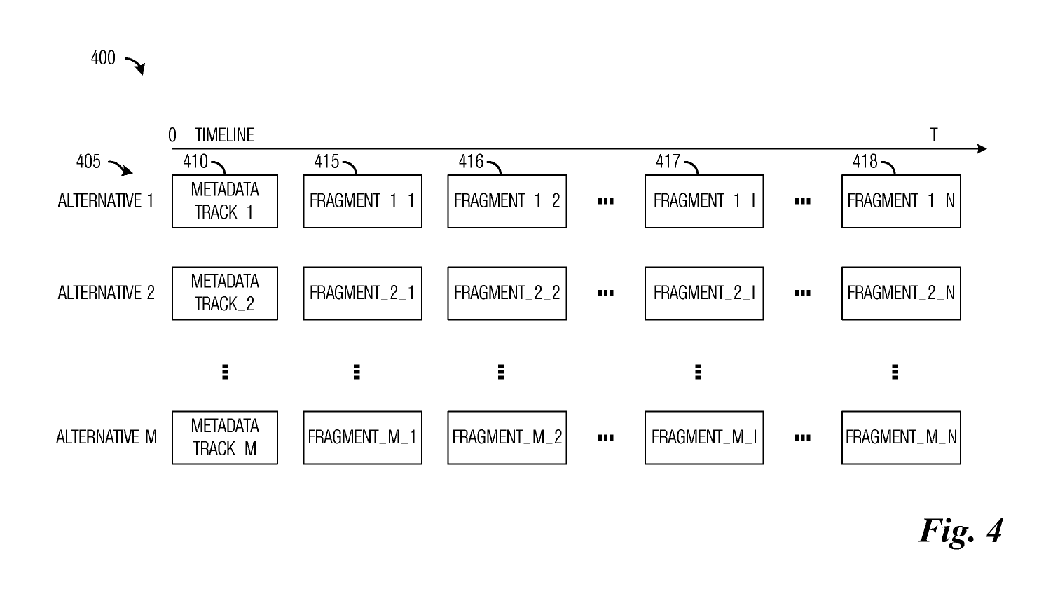

FIG. 4 illustrates a first storage structure 400 of media fragments. As shown in FIG. 4, only prepared alternatives of a media are illustrated. As an example, a first sequence of blocks 405 may represent a storage structure of a first alternative of the media. First sequence of blocks 405 may include a first file “METADATA TRACK_{—}1” 410 to store metadata for the first alternative of the media followed by N fragments, such as “FRAGMENT_{—}1_{—}1” 415, “FRAGMENT_{—}1_{—}2” 416, “FRAGMENT_{—}1_I” 417, and “FRAGMENT_{—}1_N” 418. Other alternatives of the media may be similarly fragmented.

In order to manifest a streaming server (for server controlled adaptive streaming) or a media client (for client controlled adaptive streaming) with on demand transcoding capability, metadata for additional alternatives (tracks) may also be prepared. The presence of additional metadata may declare that on demand transcoding may be utilized for the additional alternatives. Unlike prepared media tracks which have all media fragments to form a complete alternative for the media, the additional alternatives may have none or only a subset of required media fragments prepared and the missing media fragments may be generated through transcoding of existing media fragments prepared for other alternatives when demanded.

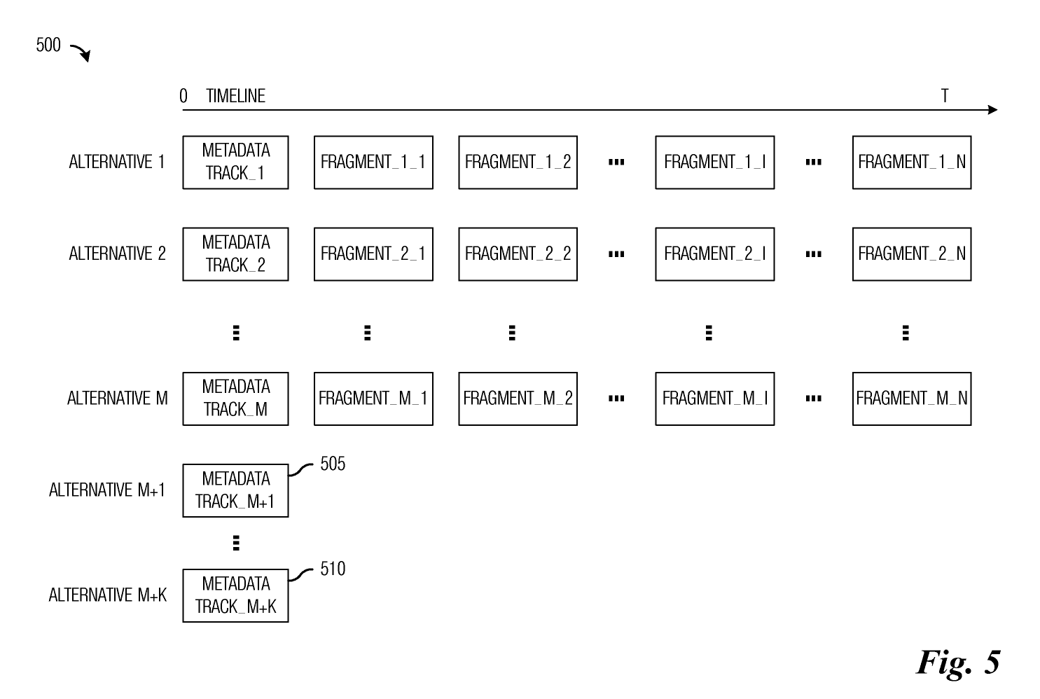

FIG. 5 illustrates a storage structure 500 of media fragments with additional prepared metadata. FIG. 5 shows additional prepared metadata, such as “METADATA TRACK_M+1” 505 and “METADATA TRACK_M+K” 510, without prepared media fragments for additional alternatives M+1 through M+K. Media fragments for additional alternatives M+1 through M+K may be generated through transcoding of existing media fragments prepared for other alternatives (e.g., existing media fragments for alternatives 1 through M) when demanded.

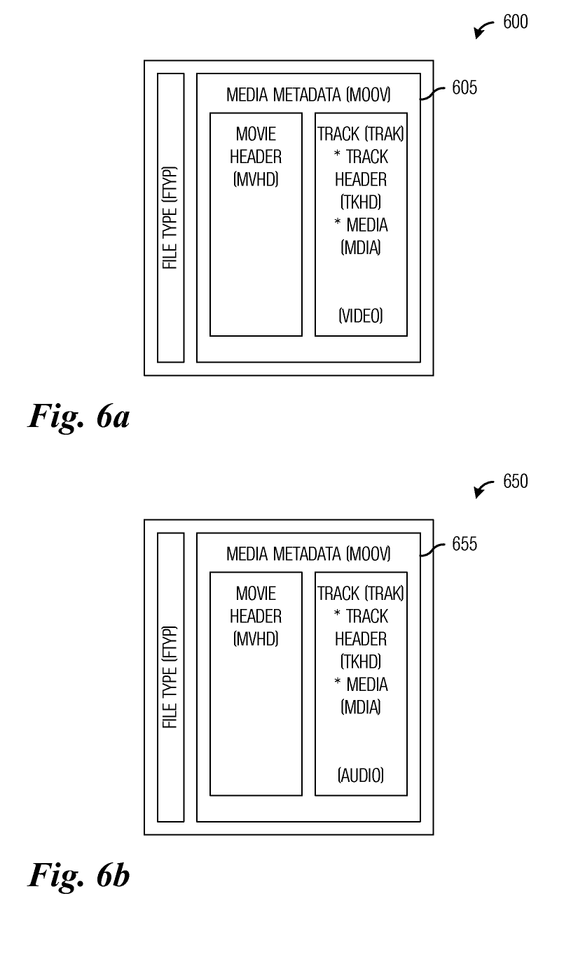

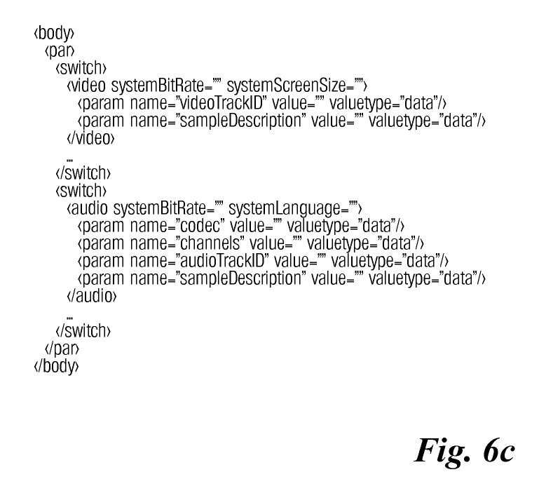

FIG. 6a illustrates a metadata format 600 for a video track. As shown in metadata format 600, media metadata 605 (moov box) may contain file and track level metadata without any sample information.

FIG. 6b illustrates a metadata format 650 for an audio track. As shown in metadata format 650, media metadata 655 (moov box) may contain file and track level metadata without any sample information.

FIG. 6c illustrates a media description of alternative tracks. As shown in FIG. 6c, the media description of the alternative tracks may include information such as video system bit-rate, video system screen size, video track ID, sample description, audio system bit-rate, system language, codec, number of channels, audio track ID, and so forth.

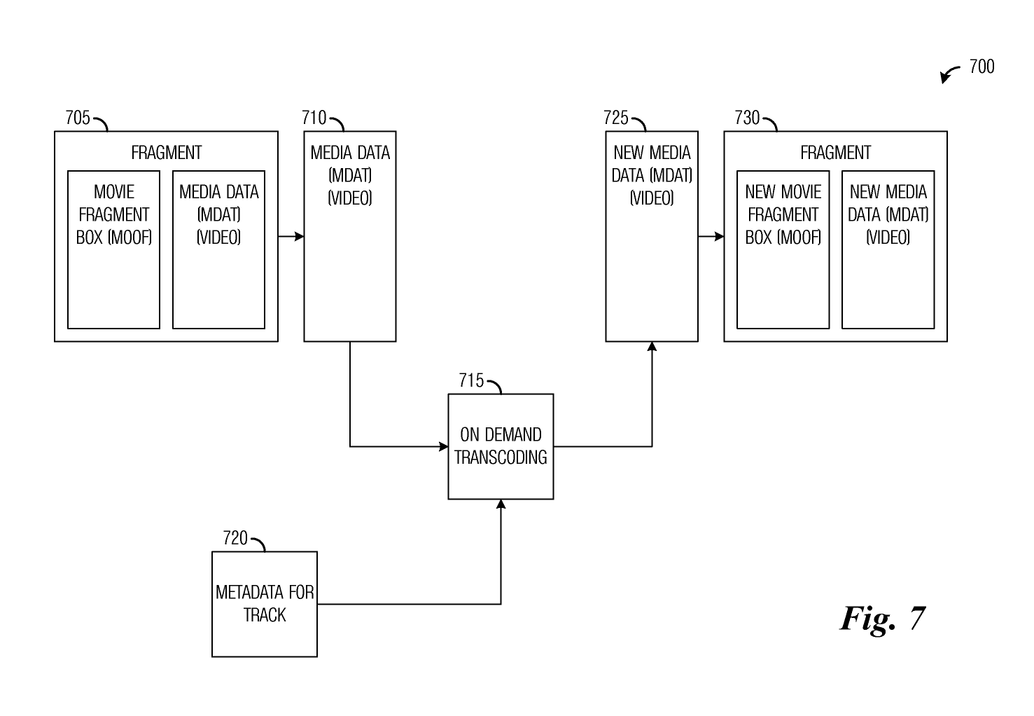

FIG. 7 illustrates a data flow 700 for a combination of MBR with on demand transcoding. As shown in FIG. 7, a media fragment, for example, a video fragment 705, at a first bit-rate may be stripped of its media data (block 710) and provided to an on demand transcoding unit 715 for transcoding to a second bit-rate. Also provided to on demand transcoding unit 715 may also be provided with metadata for the video fragment.

On demand transcoding unit 715 may transcode the media data to the second bit-rate, thereby producing new media data (block 725). The new media data may then be placed in a new media fragment 730. The new media data may be encapsulated with a video fragment header and stored as an alternative media fragment.

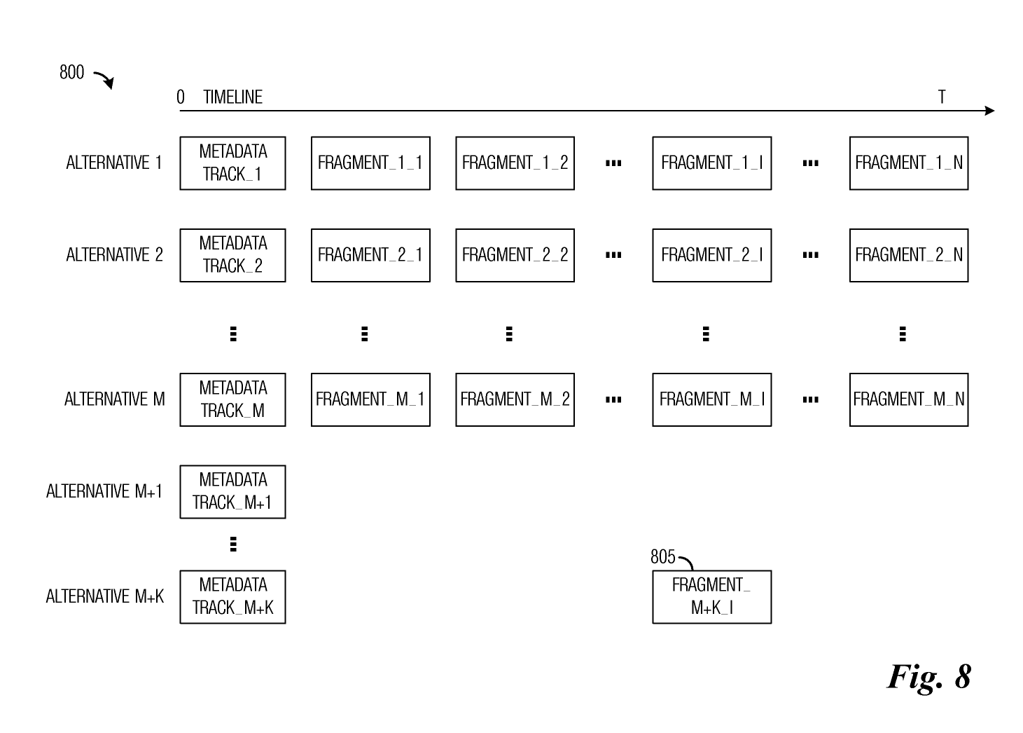

FIG. 8 illustrates a storage structure 800 of media fragments with additional prepared metadata and media fragments transcoded using on demand transcoding. Media fragment 805 for alternative media track M+K may be transcoded to a desired bit-rate by on demand transcoding. As shown in FIG. 8, media fragment 805 represents an I-th fragment of additional alternative M+K. Media fragments 1 through I−1 for additional alternative M+K are not shown in FIG. 8, indicating that these media fragments were not prepared beforehand.

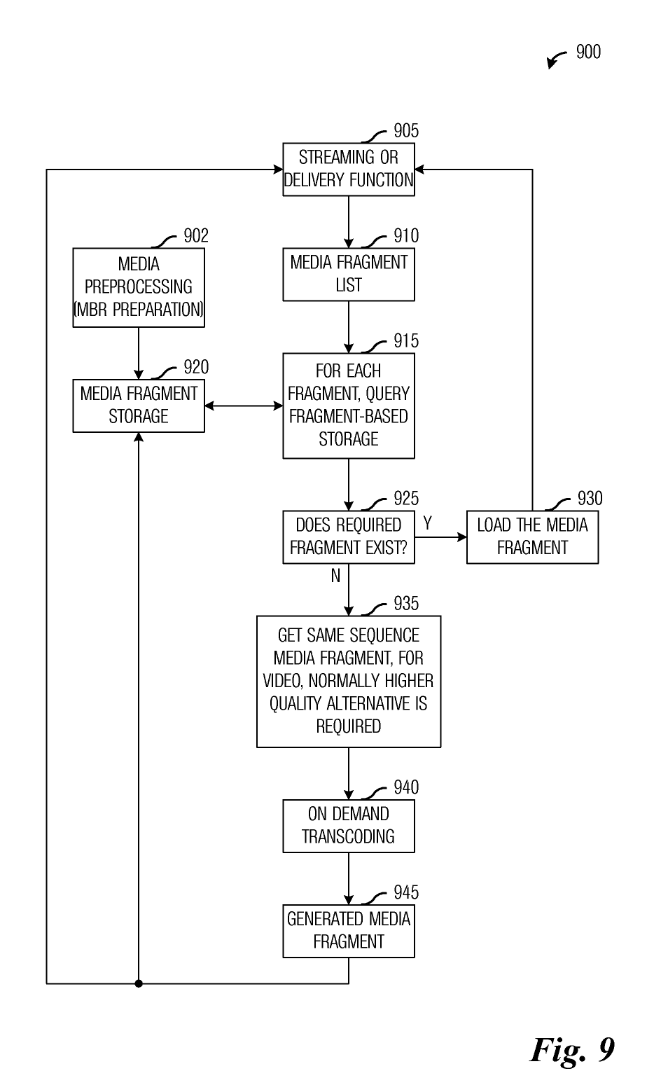

FIG. 9 illustrates a flow diagram of operations 900 in combining MBR with on demand transcoding. Operations 900 may be indicative of operations occurring in a communications system, such as communications system 100, as the communications system delivers media to a UE. Operations 900 may occur while the communications system is in a normal operating mode.

Operating in parallel or prior to operations 900, a MBR process may prepare media fragments at one or more bit-rates/resolution/etc. (block 902). The prepared media fragments may be stored in a media fragment storage for subsequent use, e.g., delivery to UEs that request delivery of the media.

Operations 900 may begin at a streaming or delivery function that receives a request for delivery of media at a first bit-rate/resolution/etc. (block 905). According to an embodiment, the first bit-rate/resolution/etc. may be dependent on factors such as UE capability, available communications system bandwidth, communications system load, communications system traffic patterns, UE subscription level, quality of service requirements, and so forth. From the request of delivery of the media, a media fragment list may be retrieved or generated (block 910). The media fragment list may be a list of individual media fragments generated from the media. According to an embodiment, the individual media fragments may be of equal size except for a last media fragment. Furthermore, the media may be fragmented in such as way that the video and the audio remain synchronized or substantially synchronized. As discussed previously, the media fragment list may include media fragments as well as metadata specifying requirements, such as bit-rate, resolution, frame rate, codec, and so forth.

For each media fragment in the media fragment list, a query to the media fragment storage may be performed to determine if the media fragment exists in the media fragment storage at the required bit-rate/resolution/etc. (block 915). If the media fragment exists in the media fragment storage at the required bit-rate/resolution/etc. (block 925), the media fragment may be loaded (retrieved) from the media fragment storage and prepared for delivery to the UE (block 930). Operations 900 may return to block 905 for additional requests.

If the media fragment does not exist in the media fragment storage at the required bit-rate/resolution/etc. (block 925), then a media fragment identical to the media fragment but at a different bit-rate/resolution/etc. may be retrieved from the media fragment storage (block 935). According to an embodiment, the media fragment retrieved from the media fragment storage may be encoded at a bit-rate/resolution/etc. that is lower than the first bit-rate/resolution/etc. According to another embodiment, the media fragment retrieved from the media fragment storage may be encoded at a bit-rate/resolution/etc. that is higher than the first bit-rate/resolution/etc.

On demand transcoding may be performed to transcode the media fragment retrieved from the media fragment storage to the first bit-rate/resolution/etc. (block 940). A complete transcoded media fragment may then be generated (block 945) and saved in the media fragment storage for subsequent use if needed (block 920). The complete transcoded media fragment may also be provided to the streaming or delivery function for delivery to the UE (block 905). Operations 900 may return to block 905 for additional requests.

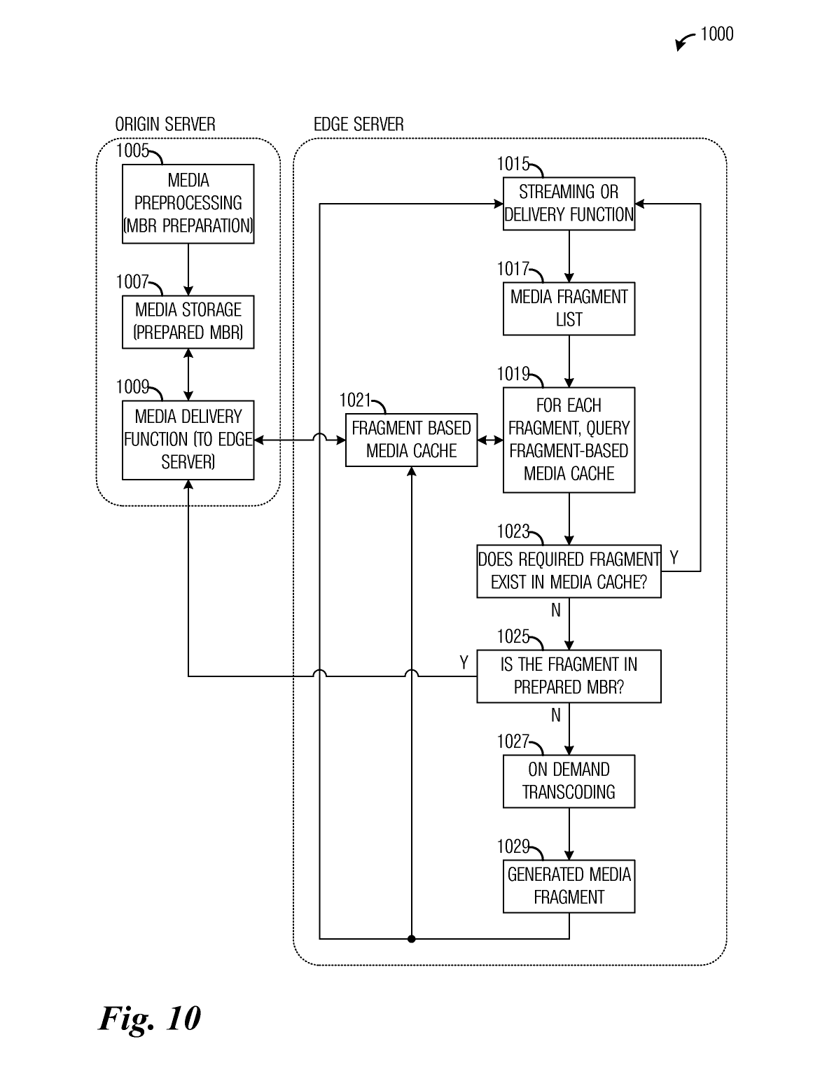

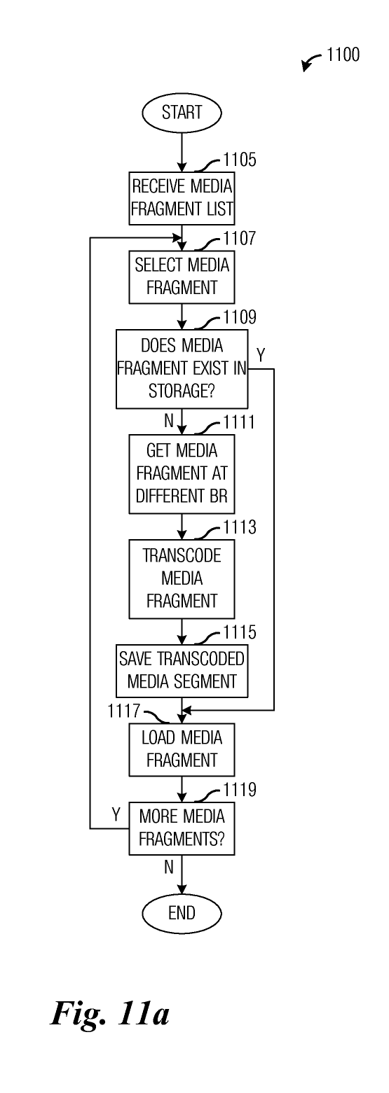

FIG. 10 illustrates a flow diagram of operations 1000 in combining MBR with on demand transcoding in a media delivery communications system. Operations 1000 include operations at an origin server, where media is initially stored, and an edge server, where media entering a private network may be stored. Operations 1000 may occur while the origin server and the edge server are in a normal operating mode.

Operations 1000 occurring in the origin server may begin with the origin server utilizing MBR to prepare media at a number of bit-rates/resolutions/etc. (block 1005). As an example, the origin server may prepare media at a bit-rate for use with high definition displays, computers, and smart telephones. The prepared media may be stored in the form of media fragments in media storage (block 1007). According to an embodiment, the media fragments may be stored in a structure such as shown in FIG. 4. A media delivery function at the origin server may deliver media fragments at a requested bit-rate/resolution/etc. to the edge server (block 1009).

Operations 1000 occurring in the edge server may begin at a streaming or delivery function that receives a request for delivery of media at a first bit-rate/resolution/etc. (block 1015). According to an embodiment, the first bit-rate/resolution/etc. may be dependent on factors such as UE capability, available communications system bandwidth, communications system load, communications system traffic patterns, UE subscription level, quality of service requirements, and so forth. From the request of delivery of the media, a media fragment list may be generated (block 1017). As discussed previously, the media fragment list may include media fragments as well as metadata specifying requirements, such as bit-rate, resolution, frame rate, codec, and so forth.

For each media fragment in the media fragment list, a query to fragment based media cache may be performed to determine if the media fragment exists in the media cache at the required bit-rate/resolution/etc. (block 1019). If the media fragment exists in the media cache at the required bit-rate/resolution/etc. (block 1021), the media fragment may be loaded (retrieved) from the media cache and prepared for delivery to the UE (block 1023). Operations 1000 may return to block 1015 for additional requests.

If the media fragment does not exist in the media cache at the required bit-rate/resolution/etc. (block 1023), then a check to determine if the media fragment exists at the origin server at the required bit-rate/resolution/etc. (block 1025). If the media fragment exists at the origin server (block 1025), then the media fragment may be delivered by the media delivery function of the origin server to the media cache (block 1009), making the media fragment available for delivery to the UE.

If the media fragment at the required bit-rate/resolution/etc. is not available at the origin server, the edge server may perform on demand transcoding to transcode a version of the media fragment at a different bit-rate/resolution/etc. to the required bit-rate/resolution/etc. (block 1027). A complete transcoded media fragment may then be generated (block 1029) and saved in the media cache for subsequent use if needed (block 1021). The complete transcoded media fragment may also be provided to the streaming or delivery function for delivery to the UE (block 1015). Operations 1000 may return to block 1015 for additional requests.

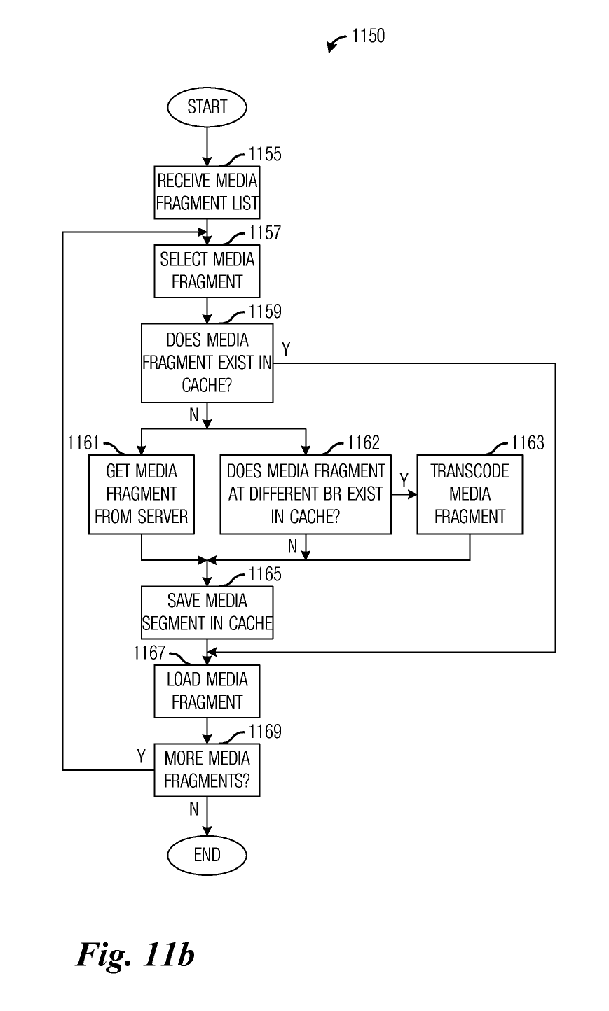

FIG. 11a illustrates a flow diagram of first server operations 1100 in a delivery of media to a UE, wherein media adaptation using a combination of MBR and on demand transcoding is utilized. First server operations 1100 may be indicative of operations occurring in a server, such as an edge server, as the server provides media at requested bit-rate/resolution/etc. to UEs operating within its communications system. First server operations 1100 may occur while the server is in a normal operating mode.

First server operations 1100 may begin with the server receiving a media fragment list (block 1105). According to an embodiment, the media fragment list may be derived from a request by a UE for media at a desired bit-rate/resolution/etc. The server may then select a media segment from the media fragment list (block 1107) and perform a check to determine if the selected media segment exists in media fragment storage (block 1109).

If the media fragment does not exist in the media fragment storage, then the server may obtain the media fragment at a different bit-rate/resolution/etc. (block 1111) and transcode the media fragment to the desired bit-rate/resolution/etc. (block 1113). The transcoded media fragment (and the media fragment at a different bit-rate/resolution/etc.) may be saved in the media fragment storage for subsequent use (block 1115).

The transcoded media fragment at the desired bit-rate/resolution/etc. or the media fragment retrieved from the media fragment storage (if the media fragment existed in the media fragment storage at the desired bit-rate/resolution/etc.) may be loaded and delivered to the UE (block 1117).

The server may then perform a check to determine if there are additional media fragments in the media fragment list (block 1119). If there are additional media fragments in the media fragment list, the server may return to block 1107 to select another media fragment from the media fragment list to deliver to the UE (and transcode if necessary). If there are no additional media fragments in the media fragment list, then first server operations 1100 may then terminate.

FIG. 11b illustrates a flow diagram of second server operations 1150 in a delivery of media to a UE, wherein media adaptation using a combination of MBR and on demand transcoding is utilized. Second server operations 1150 may be indicative of operations occurring in a server, such as an edge server, as the server provides media at requested bit-rate/resolution/etc. to UEs operating within its communications system. Second server operations 1150 may occur while the server is in a normal operating mode.

Second server operations 1150 may begin with the server receiving a media fragment list (block 1155). According to an embodiment, the media fragment list may be derived from a request by a UE for media at a desired bit-rate/resolution/etc. The server may then select a media segment from the media fragment list (block 1157) and perform a check to determine if the selected media segment exists in media fragment storage (block 1159).

If the media fragment does not exist in the media fragment storage, then the server may obtain the media fragment at the desired bit-rate/resolution/etc. from an origin server (block 1161). The media fragment at the desired bit-rate/resolution/etc. retrieved from the origin server may be saved in the media fragment storage. According to an embodiment, to potentially save processing time, while the server obtains the media fragment at the desired bit-rate/resolution/etc. from the origin server, the server may transcode the media fragment at a different bit-rate/resolution/etc. to the desired bit-rate/resolution/etc. (block 1163) if the media fragment exists in the media fragment storage but at a different bit-rate/resolution/etc. (block 1162). Which ever completes first (the retrieval of the media fragment from the origin server or the transcoding of the media fragment to the desired bit-rate/resolution/etc.) may be stored in the media fragment storage for subsequent use (block 1165). If the media fragment does not exist in the media fragment storage at a different bit-rate/resolution/etc., then the server may need to wait for the retrieval of the media fragment from the origin server since there is no media fragment to transcode.

The transcoded media fragment at the desired bit-rate/resolution/etc., the media fragment retrieved from the media fragment storage (if the media fragment existed in the media fragment storage at the desired bit-rate/resolution/etc.), or the media fragment at the desired bit-rate/resolution/etc. retrieved from the origin server may be loaded and delivered to the UE (block 1167).

The server may then perform a check to determine if there are additional media fragments in the media fragment list (block 1169). If there are additional media fragments in the media fragment list, the server may return to block 1157 to select another media fragment from the media fragment list to deliver to the UE (and transcode if necessary). If there are no additional media fragments in the media fragment list, then second server operations 1150 may then terminate.

Although the present invention and its advantages have been described in detail, it should be understood that various changes, substitutions and alterations can be made herein without departing from the spirit and scope of the invention as defined by the appended claims.

Moreover, the scope of the present application is not intended to be limited to the particular embodiments of the process, machine, manufacture, composition of matter, means, methods and steps described in the specification. As one of ordinary skill in the art will readily appreciate from the disclosure of the present invention, processes, machines, manufacture, compositions of matter, means, methods, or steps, presently existing or later to be developed, that perform substantially the same function or achieve substantially the same result as the corresponding embodiments described herein may be utilized according to the present invention. Accordingly, the appended claims are intended to include within their scope such processes, machines, manufacture, compositions of matter, means, methods, or steps.

What is claimed is:

1. A method for providing media to an electronic device, the method comprising:
receiving a request for a media with a set of characteristics;
determining if the media with the set of characteristics resides in a media storage;
if the media with the set of characteristics resides in the media storage, retrieving the media with the set of characteristics from the media storage;
if the media with the set of characteristics does not reside in the media storage, transcoding an alternate media with an alternate set of characteristics to produce a transcoded media with the set of characteristics; and
providing the media with the set of characteristics from the media storage or the transcoded media with the set of characteristics to the electronic device.

2. The method of claim 1, wherein the media comprises a plurality of media fragments, and wherein the method further comprises:
retrieving a media fragment list for the media; and
selecting a media fragment from the media fragment list.

3. The method of claim 2, wherein the determining if the media with the set of characteristics resides in a media storage, the if the media with the set of characteristics resides in the media storage, the if the media with the set of characteristics does not reside in the media storage, and the providing all operate with the selected media fragment.

4. The method of claim 2, wherein the selecting a media fragment, the determining if the media with the set of characteristics resides in a media storage, the if the media with the set of characteristics resides in the media storage, the if the media with the set of characteristics does not reside in the media storage, and the providing are repeated for each media fragment in the media fragment list.

5. The method of claim 2, wherein retrieving a media fragment list comprises retrieving the media fragment list for the media from a server.

6. The method of claim 1, wherein transcoding an alternate media comprises:
obtaining the alternate media from a server; and
transcoding the alternate media obtained from the server to produce the transcoded media with the set of characteristics.

7. The method of claim 6, wherein transcoding an alternative media further comprises storing the transcoded media with the set of characteristics in the media storage.

8. The method of claim 6, wherein transcoding an alternative media further comprises storing the alternate media in the media storage.

9. The method of claim 1, wherein determining if the media with the set of characteristics resides in a media storage comprises searching the media storage for the media with the set of characteristics.

10. The method of claim 9, wherein searching the media storage comprises:
applying a hashing function to the media with the set of characteristics; and
searching the media storage using a result of the hashing function.

11. The method of claim 1, wherein providing the media with the set of characteristics from the media storage or the transcoded media with the set of characteristics to the electronic device comprises transmitting the media with the set of characteristics from the media storage or the transcoded media with the set of characteristics to the electronic device.

12. A method for providing media to an electronic device, the method comprising:
receiving a request for a media with a set of characteristics;
determining if the media with the set of characteristics resides in a media storage;
if the media with the set of characteristics resides in the media storage, retrieving the media with the set of characteristics from the media storage;
if the media with the set of characteristics does not reside in the media storage,
transcoding an alternate media with an alternate set of characteristics to produce a transcoded media with the set of characteristics, or
retrieving the media with the set of characteristics from a media server; and
providing the media with the set of characteristics from the media storage, the media with the set of characteristics from the media server, or the transcoded media with the set of characteristics to the electronic device.

13. The method of claim 12, wherein the media comprises a plurality of media fragments, and wherein the method further comprises:
retrieving a media fragment list for the media; and
selecting a media fragment from the media fragment list.

14. The method of claim 13, wherein the determining if the media with the set of characteristics resides in a media storage, the if the media with the set of characteristics resides in the media storage, the if the media with the set of characteristics does not reside in the media storage, and the providing all operate with the selected media fragment.

15. The method of claim 13, wherein the selecting a media fragment, the determining if the media with the set of characteristics resides in a media storage, the if the media with the set of characteristics resides in the media storage, the if the media with the set of characteristics does not reside in the media storage, and the providing are repeated for each media fragment in the media fragment list.

16. The method of claim 12, wherein transcoding an alternate media comprises:
obtaining the alternate media from the media storage; and
transcoding the alternate media obtained from the server to produce the transcoded media with the set of characteristics.

17. The method of claim 16, wherein transcoding an alternate media further comprises storing the transcoded media with the set of characteristics to the media storage.

18. The method of claim 12, wherein retrieving the media with the set of characteristics from a media server comprises sending a request for the media with the set of characteristics to the media server.

19. The method of claim 18, wherein retrieving the media with the set of characteristics from a media server further comprises:
receiving the media with the set of characteristics from the media server; and
storing the media with the set of characteristics from the media server to the media storage.

20. The method of claim 12, wherein the transcoding an alternate media with an alternate set of characteristics to produce a transcoded media with the set of characteristics and the retrieving the media with the set of characteristics from a media server are initiated concurrently.

21. The method of claim 20, wherein the media with the set of characteristics does not reside in the media storage, and wherein providing the media with the set of characteristics from the media storage, the media with the set of characteristics from the media server, or the transcoded media with the set of characteristics to the electronic device comprises providing either the media with the set of characteristics from the media server or the transcoded media with the set of characteristics to the electronic device, whichever completes first.

22. An electronic device comprising:
a receiver configured to receive incoming information from a data input port;
a transmitter configured to transmit outgoing information to a data output port;
a controller coupled to the transmitter and to the receiver, the controller configured to combine fixed bit-rate media with on demand transcoding of media fragments to produce a media stream with support for a wide range of properties; and
a memory coupled to the controller, to the receiver, and to the transmitter, the memory configured to store media fragments.

23. The electronic device of claim 22, wherein the controller comprises:
a media fragment query unit configured to determine if a media fragment with a set of characteristics is present in media fragment store;
a media fragment store control unit coupled to the media fragment query unit, the media fragment store control unit configured to store and retrieve media fragments from the media fragment store;
a transcoder unit coupled to the media fragment query unit, the transcoder unit configured to encode a first media fragment with a first set of characteristics into a transcoded media fragment with a second set of characteristics; and
a combine unit coupled to the media fragment query unit, to the media fragment store control unit, and to the transcoder, the combine unit configured to combine media fragments from the media fragment store and transcoded media fragments produced by the transcoder unit to produce the media stream.

24. The electronic device of claim 23, wherein the controller further comprises a media request unit coupled to the media fragment query unit, to the transcoder unit, and to the combine unit, the media request unit configured to process a received media request.

25. The electronic device of claim 23, wherein the controller further comprises a media delivery unit coupled to the media fragment store control unit and to the transcoder unit, the media delivery unit configured to ensure a sequencing of media fragments in the media stream.
